(19) United States
(12) Patent Application Publication
(10) Pub. No.: US 2023/0314586 A1
(43) Pub. Date: Oct. 5, 2023

(54) RADAR APPARATUS

(71) Applicant: Mitsubishi Electric Corporation, Tokyo (JP)

(72) Inventor: Tatsuya KAMIMURA, Tokyo (JP)

(73) Assignee: Mitsubishi Electric Corporation, Tokyo (JP)

(21) Appl. No.: 18/024,775

(22) PCT Filed: Oct. 5, 2020
(86) PCT No.: PCT/JP2020/037770

§ 371 Date: Mar. 6, 2023

(51) Int. Cl. G01S 13/34

(52) U.S. Cl. CPC G01S 13/34; G01S 7/35

(57) ABSTRACT

A radar apparatus includes an antenna unit that emits radar waves into space, a high-frequency circuit that receives, via the antenna unit, reflected waves of the radar waves reflected from a target, and a baseband circuit that converts reception signals output from the high-frequency circuit into digital baseband signals. A plurality of reception channels is formed in the antenna unit, the high-frequency circuit, and the baseband circuit. The baseband circuit includes: a baseband amplifier that amplifies reception signals output from the high-frequency circuit, and adds amplified parallel reception signals together, on a per reception-channel basis; and an analog-to-digital converter that converts an analog signal output from the baseband amplifier into a digital value.

### FIELD

The present disclosure relates to a radar apparatus that detects a target.

### BACKGROUND

Patent Literature 1 below discloses a frequency modulation technique applicable to a fast chirp modulation (FCM) radar. The FCM radar has features such as a simple configuration, a relatively low frequency band of transmission/reception beat signals subjected to baseband processing, and ease of handling. The FCM radar, which has these features, has been widely used as an automobile collision prevention millimeter-wave radar. It is thus thought that the FCM radar will be used as one of sensors for automatic driving in the future.

A conventional typical FCM radar disclosed in Patent Literature 1 is generally configured such that a high-frequency circuit is provided with a low noise amplifier (LNA). In a radar apparatus with such a configuration, noise of the LNA dominates a signal-to-noise ratio (SNR) of a reception channel.

### CITATION LIST

### Patent Literature

Patent Literature 1: Japanese Patent No. 6351910

### SUMMARY

### Technical Problem

Unfortunately, it is difficult to improve the reception SNR of the LNA in a millimeter-wave band used in an automobile sensor and a high-frequency band equivalent to or exceeding the millimeter-wave band. As a result, the conventional radar apparatus suffers from the problem of the LNA limiting a reception SNR of the entire radar apparatus.

The present disclosure has been made in view of the above, and an object of the present disclosure is to obtain a radar apparatus capable of improving a reception SNR of the entire apparatus without providing a high-frequency circuit with an LNA.

### Solution to Problem

In order to solve the above problem and achieve the object, a radar apparatus according to the present disclosure comprises: an antenna unit to emit radar waves into space; a high-frequency circuit to receive, via the antenna unit, a reflected wave of the radar wave from a target; and a baseband circuit to convert reception signals output from the high-frequency circuit into digital baseband signals. A plurality of reception channels is formed in the antenna unit, the high-frequency circuit, and the baseband circuit. The baseband circuit includes: a baseband amplifier to amplify reception signals output from the high-frequency circuit and add amplified parallel reception signals together, on a per reception-channel basis; and an analog-to-digital converter to convert an analog signal output from the baseband amplifier into a digital value.

### Advantageous Effects of Invention

The radar apparatus according to the present disclosure has the effect of improving the reception SNR of the entire apparatus without providing the high-frequency circuit with the LNA.

### BRIEF DESCRIPTION OF DRAWINGS

FIG. 1 is a block diagram showing a configuration example of a radar apparatus according to an embodiment.

FIG. 2 is a diagram showing an example of a frequency-modulated high-frequency signal to be output from a local unit in FIG. 1.

FIG. 3 is a diagram quantitatively illustrating a relationship between the parallel addition number of a BBA and the degree of improvement of a reception SNR in the configuration of FIG. 1.

FIG. 4 is a block diagram showing an example in which a micro control unit (MCU) in the embodiment is defined by an individual circuit.

### DESCRIPTION OF EMBODIMENT

A radar apparatus according to an embodiment of the present disclosure will be hereinafter described in detail with reference to the accompanying drawings. Note that an FCM radar will be described as an example in the following embodiment, but this does not exclude application to radar apparatuses other than the FCM radar. Furthermore, in the following description, electrical connection and physical connection are simply referred to as “connection” without being particularly distinguished from each other.

### Embodiment

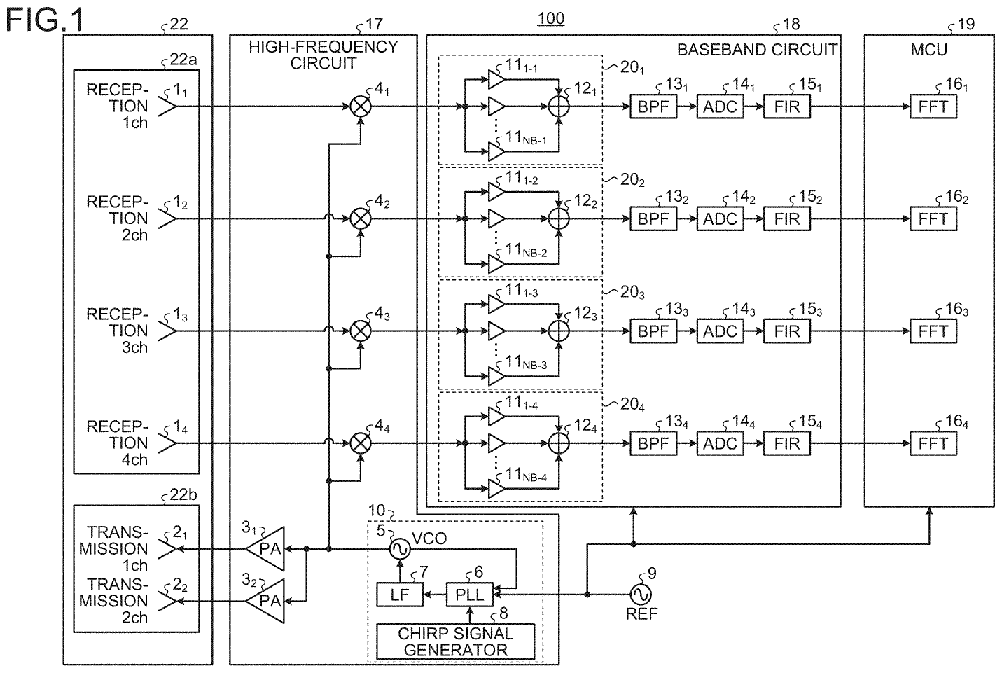

FIG. 1 is a block diagram showing a configuration example of a radar apparatus 100 according to an embodiment. As illustrated in FIG. 1, the radar apparatus 100 according to the embodiment includes an antenna unit 22, a reference signal source 9, a high-frequency circuit 17, a baseband circuit 18, and an MCU 19. The reference signal source 9 generates a reference signal REF. The high-frequency circuit 17, the baseband circuit 18, and the reference signal source 9 form a “transmission/reception unit”, and the MCU 19 forms a “signal processing unit”.

The antenna unit 22 includes a reception array 22a and a transmission array 22b. The reception array 22a includes reception antennas 1₁ to 1₄. The transmission array 22b includes transmission antennas 2₁ and 2₂. In a case where the radar apparatus 100 is used as an automobile collision prevention millimeter-wave radar, the reception antennas 1₁ to 1₄ and the transmission antennas 2₁ and 2₂ are arranged in a horizontal direction and in a direction orthogonal to the direction of travelling of an automobile.

Subscripts in the reception antennas 1₁ to 1₄ and the transmission antennas 2₁ and 2₂ identify channels (chs). In a case where the reception antennas 1₁ to 1₄ are not individually distinguished in the following description, the reception antennas 1₁ to 1₄ are hereinafter referred to as “reception antennas 1” with no subscripts. In a case where the transmission antennas 2₁ and 2₂ are not individually distinguished, the transmission antennas 2₁ and 2₂ are hereinafter referred to as “transmission antennas 2” with no subscripts. Such reference applies to other components with subscripts added for identification.

Furthermore, a channel refers to a set of processing units including elements of the transmission/reception unit and the signal processing unit to be processed by a single reception antenna 1 or a single transmission antenna 2. The channel of the reception antenna 1 may be hereinafter referred to as a “reception channel”, and the channel of the transmission antenna 2 may be referred to as a “transmission channel”. In FIG. 1, the number of reception channels is four, and the number of transmission channels is two. A reception channel to be connected to the reception antenna 1₁ is hereinafter referred to as a “reception 1 ch”. Reception channels to be connected to the reception antennas 1₂ to 1₄ and transmission channels to be connected to the transmission antennas 2₁ and 2₂ are referred to in the same manner.

The high-frequency circuit 17 includes mixers (MIXs) 4₁ to 4₄, power amplifiers (PAs) 3₁ and 3₂, and a local unit 10. The local unit 10 includes a voltage controlled oscillator (VCO) 5, a phase locked loop (PLL) 6, a loop filter (LF) 7, and a chirp signal generator 8 that is a generator of chirp signals.

The baseband circuit 18 includes baseband amplifiers (BBAs) 20₁ to 20₄, band-pass filters (BPFs) 13₁ to 13₄, analog-to-digital converters (ADCs) 14₁ to 14₄, and finite impulse response filters (FIR filters) 15₁ to 15₄. The FIR filter is an example of a digital filter.

The BBA 20₁ includes NB parallel connected amplifiers (PCAs) 11₁₋₁ to 11_{NB-1} and an adder 12₁. The symbol “NB”, which is an integer greater than or equal to 2, denotes a parallel addition number. The parallel addition number is the number of combined parallel elements to be added together in the reception 1 ch. The PCAs 11₁₋₁ to 11_{NB-1} are voltage amplifiers having the equivalent voltage gain and the equivalent phase characteristic. The adder 12₁ adds up signals output from the PCAs 11₁₋₁ to 11_{NB-1}.

The BBAs 20₂ to 20₄ are configured in the same manner. That is, the BBA 20₂ includes NB PCAs 11₁₋₂ to 11_{NB-2} and an adder 12₂. The BBA 20₃ includes NB PCAs 11₁₋₃ to 11_{NB-3} and an adder 123. The BBA 20₄ includes NB PCAs 11₁₋₄ to 11_{NB-4} and an adder 12₄.

The MCU 19 includes FFT processing units 16₁ to 16₄ that perform fast Fourier transform (FFT) as Fourier transform processing. The “FFT processing unit” is hereinafter abbreviated as “FFT”.

The MIXs 4, the BBAs 20, the BPFs 13, the ADCs 14, the FIRs 15, and the FFTs 16 are provided in a one-to-one correspondence to the reception antennas 1 of the reception array 22a. That is, each of the MIX 4, the BBA 20, the BPF 13, the ADC 14, the FIR 15, and the FFT 16 is the same in number as the reception channel.

Note that the number of reception channels is four in FIG. 1, but the number of reception channels is not limited thereto. When a plurality of reception channels is provided, the effect of the first embodiment can be enjoyed. Furthermore, although the number of transmission channels is two in FIG. 1, the number of transmission channels is not limited thereto. The number of transmission channels may be one, or may be three or more.

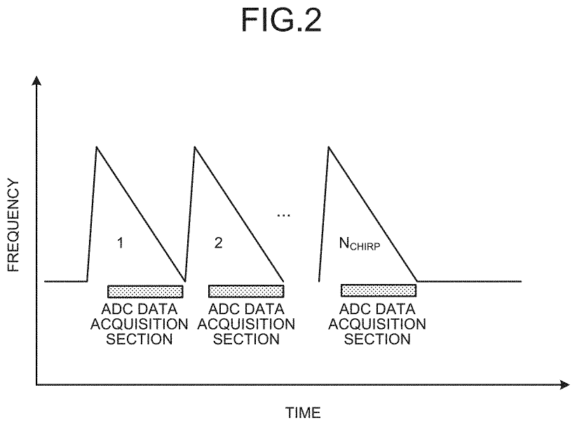

Next, the operation of the radar apparatus 100 according to the embodiment will be described with reference to FIGS. 1 and 2. FIG. 2 is a diagram showing an example of a frequency-modulated high-frequency signal to be output from the local unit 10 in FIG. 1.

The reference signal REF, and a chirp signal generated by the chirp signal generator 8 are input to the PLL 6. The PLL 6 modulates the frequency of the reference signal REF with a modulation pattern provided by the chirp signal. The signal frequency-modulated by the PLL 6 is band-limited by the LF 7 and input to the VCO 5. The VCO 5 cooperates with the PLL 6 to output a frequency-modulated high-frequency signal. The high-frequency signal output from the VCO 5 includes a sawtooth-shaped up-chirp signal or a sawtooth-shaped down-chirp signal. The up-chirp signal is a signal that increases in frequency with the lapse of time. The down-chirp signal is a signal that decreases in frequency with the lapse of time.

FIG. 2 illustrates an example of a sawtooth wave which is a down-chirp signal having frequency that changes from high frequency to low frequency in a constant slope. The horizontal axis represents time, and the vertical axis represents frequency. Note that the number of continuously output sawtooth waves illustrated in FIG. 2 is N_{CHIRP}, but the number of continuously output sawtooth waves is not limited thereto. The number of continuously output sawtooth waves can be freely set.

Each of the PAs 3 amplifies the high-frequency signal into obtain desired power, and outputs the amplified high-frequency signal to the corresponding transmission antenna 2. The transmission antennas 2 convert the high-frequency signals into radar waves that are radio waves, and emit this radar waves into space.

The high-frequency circuit 17 has a function of receiving, via the reception array 22a of the antenna unit 22, reflected waves of the transmitted radar waves from a target, and transmitting the thus received signals to the baseband circuit 18 provided at a stage following the high-frequency circuit 17.

In order to implement the above function, the MIXs 4 down-convert signals output from the reception antennas 1 into signals in an intermediate frequency (IF) band by using a local signal output from the local unit 10. Note that the local signal is linearly modulated in the FCM radar. As a result, generally, the MIXs 4 outputs sine-wave signals. Signals output from the high-frequency circuit 17 are hereinafter referred to as “reception signals”.

The baseband circuit 18 has a function of converting the reception signals output from the high-frequency circuit 17 into digital baseband signals.

In order to implement the above function, the BBAs 20 amplify signals output from the high-frequency circuit 17 and add the amplified parallel signals together, on a per reception-ch basis. The BPFs 13 limit the bands of the signals amplified by the BBAs 20. The signals having the bands limited by the BPFs 13 are transmitted to the ADCs 14.

The ADCs 14 convert analog signals output from the BPFs 13 into digital values. In a case where the high-frequency signal output from the VCO 5 is a down-chirp signal, ADC data is acquired in a section where frequency decreases in a constant slope as illustrated in FIG. 2.

The FIRs 15 perform band limitation and decimation processing on digital signals provided by the ADCs 14. The digital baseband signals subjected to the band limitation and the decimation processing are transmitted to the MCU 19.

Using the baseband signals output from the baseband circuit 18, the MCU 19 performs arithmetic processing for obtaining radar information such as a distance to a target, a relative speed of the target, and a direction of the target. This arithmetic processing is performed by the FFTs 16.

The operation of the BBA 20 will be described in more detail. In the BBA 20, the NB PCAs 11 amplify voltages of the same reception signals output from the MIX 4. The adder 12 sums the individual signals output from the PCAs 11. The input impedance of each BBA 20 is set sufficiently larger than the output impedance of the corresponding MIX 4. As a result, the BBA 20 operates as a voltage amplifier. The input impedance of the BBA 20 is 5 kΩ, for example. Furthermore, the output impedance of the MIX 4 is 50Ω, for example.

The phases of reception beat signals output from the individual NB PCAs 11 correlate with each other. For this reason, the adder 12 performs voltage addition of the reception beat signals output from the individual PCAs 11. Meanwhile, noise generated in each of the NB PCAs 11 is mainly thermal noise, flicker noise, etc. These types of noise have no correlation with each other. For this reason, the noises generated in the individual PCAs 11 are subjected to power addition in the adder 12. Thus, the parallel reception beat signals to be added together by the adder 12 each have a higher voltage intensity than noise. As a result, the reception SNR of the BBA 20 is improved in proportion to the parallel addition number of the PCAs 11.

As described above, the radar apparatus 100 according to the embodiment includes no LNA between the reception antennas 1 and the MIXs 4, as illustrated in FIG. 1. In a case where the output noises of the MIXs 4 are smaller than the input-referred noises of the BBAs 20, the reception SNRs of the BBAs 20 dominate the reception SNR of the entire radar apparatus 100. This means that the reception SNRs of the BBAs 20 are improved to thereby improve the reception SNR of the entire radar apparatus 100. As a result, the radar apparatus 100 can enjoy an effect of detecting a more distant target and an effect of detecting a target having a smaller reflection intensity.

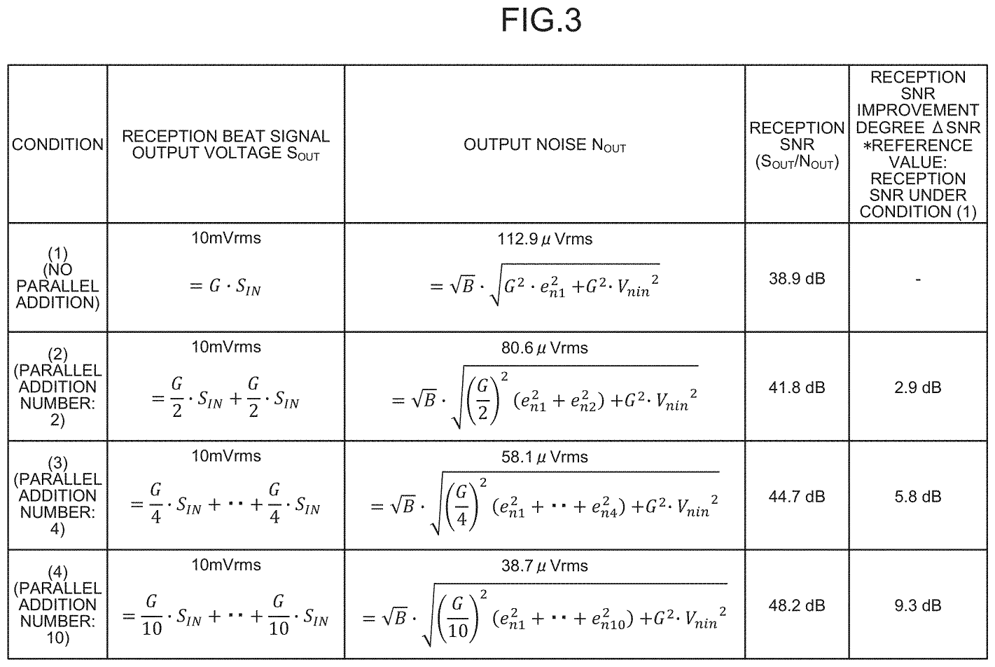

The effect of improving an SNR in the BBA 20 will be further described quantitatively with reference to FIG. 3. FIG. 3 is a diagram quantitatively illustrating a relationship between the parallel addition number of the BBA 20 and the degree of improvement of a reception SNR in the configuration of FIG. 1. FIG. 3 illustrates the reception SNR of the BBA 20, and ASNR in cases (1) to (4) set forth below. ASNR is the degree of improvement of the reception SNR. Note that these four cases are based on the assumption that the voltage gains of the BBAs 20 are equal in all the four cases. Each condition in the four cases will be described below.
Voltage gain of BBA 20: G
(1) to (4): 10 times (common)
Voltage gain of PCA 11: G_{PCA}
(1): 10 times (G_{PCAA}=G), (2): 5 times (G_{PCA}=G/2),
(3): 2.5 times (G_{PCA}=G/4), (4): 1 time (G_{PCA}=G/10)
Parallel addition number of PCAs 11: NB
(1): 1, (2): 2, (3): 4, (4): 10
Input-referred noise in PCA 11: eₙ
(1) to (4): 5 nVrms/√Hz (common)

Note that the assumption is that the input-referred noises eₙ in the individual PCAs 11 in the BBA 20 are all equal. That is, eₙ=eₙ₁=eₙ₂= . . . =en₁₀.
Input noise of PCA 11: Vₙᵢₙ (=output noise of MIX 4)
(1) to (4): 0.7 nVrms/√Hz (common)

PCA input voltage level of reception beat signal: S_{IN}
(1) to (4): 1 mVrms
Frequency bandwidth: B
(1) to (4): 5 MHz (common)

In FIG. 3, S_{OUT} represents the output voltage of the reception beat signal, that is, the output voltage of the BBA 20 under each condition. In addition, N_{OUT} is output noise obtained by synthesis of output noise generated inside the BBA 20 and output noise of the MIX 4 amplified by the BBA 20, based on the root mean square under each condition. The reception SNR, which is a ratio of the output voltage S_{OUT} to the output noise N_{OUT}, is expressed by the formula “SNR=S_{OUT}/N_{OUT}” in terms of dB. In addition, dSNR, which is the degree of improvement of the reception SNR, represents, in terms of dB, a difference between the reception SNR under condition (1) and the reception SNR under each of conditions (2) to (4). The reception SNR under condition (1) is a reference value. FIG. 3 indicates that when the parallel addition number is 2, the reception SNR is improved by 2.9 dB as compared with the reception SNR under condition (1) that performs no parallel addition. Furthermore, FIG. 3 indicates that when the parallel addition number is 4, the reception SNR is improved by 5.8 dB as compared with the reception SNR under condition (1), and that when the parallel addition number is 10, the reception SNR is improved by 9.3 dB as compared with the reception SNR under condition (1).

Note that, in a case where the input noise of the BBA 20 is negligibly smaller than the input-referred noise of the BBA 20, the degree of improvement “ASNR” of the reception SNR can be expressed as generalized formula (A) below for any given parallel addition number NB on the basis of the relationship of FIG. 3.

ΔSNR=10×log(NB) (A)

As described above, the radar apparatus 100 according to the embodiment is configured to add together the parallel signals, using the PCAs 11 and the adder 12, thereby achieving the effect of improving the reception SNR. Furthermore, the radar apparatus 100 according to the embodiment can achieve the effect of enabling the parallel addition number to control the degree of improvement of the reception SNR.

Note that FIG. 1 illustrates, by way of example, the four reception channels and the two transmission channels, but the number of reception channels and the number of transmission channels are not limited to these examples. The number of transmission channels and the number of reception channels can be increased or decreased. Similarly, the parallel addition number NB of the PCAs 11 in BBA 20 can also be increased or decreased.

Furthermore, the high-frequency circuit 17, the baseband circuit 18, and the MCU 19 have been described as individual circuits in FIG. 1, but the circuit configuration thereof is not limited to this example. The high-frequency circuit 17, the baseband circuit 18, and the MCU 19 may be integrally integrated into a single chip by integrated circuit technology using a SiGe process or a CMOS process.

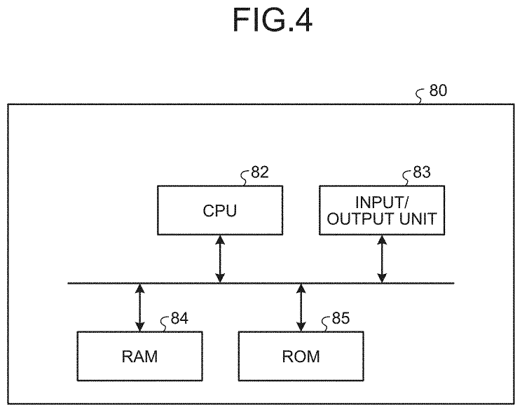

In addition, FIG. 4 is a block diagram illustrating an example in which the MCU 19 in the embodiment is defined by an individual circuit 80. To implement the functions of the FFTs 16 of the MCU 19, the individual circuit 80 may include a central processing unit (CPU) 82, an input/output unit 83, a random access memory (RAM) 84, and a read only memory (ROM) 85, as illustrated in FIG. 4. The CPU 82 performs arithmetic processing. The input/output unit 83 is an input/output interface between the circuit 80 and an external device. The RAM 84 includes a program storage area and a data storage area. The ROM 85 is a nonvolatile memory. The CPU 82 may be a computing means such as a microprocessor, a microcomputer, a processor, or a digital signal processor (DSP).

The ROM 85 stores programs for various processes and databases to be referred to in the various processes. The programs and the databases may be recorded in a readable and writable recording medium other than the ROM 85. The recording medium may be a hard disk device, or may be any of a compact disc read only memory (CD-ROM), a digital versatile disc (DVD), and a universal serial bus (USB) memory that are portable recording media. Alternatively, the recording medium may be a flash memory that is a semiconductor memory.

The programs are loaded into the RAM 84. The CPU 82 executes various processes by deploying the programs in the program storage area in the RAM 84 and exchanging necessary information via the input/output unit 83. The data storage area in the RAM 84 is a work area for execution of the various processes. The function of the MCU 19 described above is implemented using the CPU 82.

As described above, the baseband circuit of the radar apparatus according to the embodiment includes: a baseband amplifier that amplify reception signals output from the high-frequency circuit and add the amplified parallel reception signals together, on a per reception-channel basis; and an analog-to-digital converter that converts an analog signal output from the baseband amplifier into a digital value. With this configuration, the radar apparatus can obtain the effect of improving the reception SNR of the entire apparatus without providing the high-frequency circuit with a low noise amplifier.

Note that the configurations set forth in the above embodiment show examples, and it is possible to combine the configurations with another known technique, and is also possible to partially omit or change the configurations without departing from the scope of the present disclosure.

### REFERENCE SIGNS LIST

1, 1₁ to 1₄ reception antenna; 2, 2₁, 2₂ transmission antenna; 3, 3₁, 3₂ PA; 4, 4₁ to 4₄ MIX; 5 VCO; 6 PLL; 7 LF; 8 chirp signal generator; 9 reference signal source; 10 local unit; 11, 11₁₋₁ to 11_{NB-1}, 11₁₋₂ to 11_{NB-2}, 11₁₋₃ to 11_{NB-3}, 11₁₋₄ to 11_{NB-4} PCA; 12, 12₁ to 12₄ adder; 13, 13₁ to 13₄ BPF; 14, 14₁ to 14₄ ADC; 15, 15₁ to 15₄ FIR; 16, 16₁ to 16₄ FFT; 17 high-frequency circuit; 18 baseband circuit; 19 MCU; 20, 20₁ to 20₄ BBA; 22 antenna unit; 22a reception array; 22b transmission array; 80 individual circuit; 82 CPU; 83 input/output unit; 84 RAM; 85 ROM; 100 radar apparatus.

1. A radar apparatus comprising:
antennas to emit radar waves into space;
a high-frequency circuit to receive, via the antennas, a reflected wave of the radar wave from a target; and
a baseband circuit to convert reception signals output from the high-frequency circuit into digital baseband signals, wherein
a plurality of reception channels is formed in the antennas, the high-frequency circuit, and the baseband circuit, the reception signals are output from the high-frequency circuit not via a low noise amplifier, and
the baseband circuit includes:
a baseband amplifier to amplify voltages of same reception signals output from the high-frequency circuit and add amplified parallel reception signals together, on a per reception-channel basis; and
an analog-to-digital converter to convert an analog signal output from the baseband amplifier into a digital value.

2. The radar apparatus according to claim 1, wherein:
the baseband amplifier is plural in number, and each of the plurality of the baseband amplifiers includes, on a per reception-channel basis,
NB voltage amplifiers to amplify ag voltages of the same reception signals having same voltages, NB being an integer greater than or equal to two; and
an adder to add together individual signal outputs from the plurality of voltage amplifiers.

3. The radar apparatus according to claim 2, wherein a voltage gain of each of the voltage amplifiers is one-NBth of a voltage gain of a corresponding one of the baseband amplifiers.
